(19) United States
(12) Patent Application Publication
(10) Pub. No.: US 2020/0065657 A1
(43) Pub. Date: Feb. 27, 2020

(54) MACHINE LEARNING SYSTEM AND BOLTZMANN MACHINE CALCULATION METHOD

(71) Applicant: Hitachi, Ltd., Tokyo (JP)

(72) Inventor: Hiroshi UCHIGAITO, Tokyo (JP)

(21) Appl. No.: 16/505,747

(22) Filed: Jul. 9, 2019

(30) Foreign Application Priority Data
Aug. 27, 2018 (JP) 2018-158443

(51) Int. Cl. G06N 3/04; G06N 3/08

(52) U.S. Cl. CPC G06N 3/0472; G06N 3/08

(57) ABSTRACT

Provided is a machine learning system aimed at achieving power saving and circuit scale reduction of learning and inference processing in machine learning. The machine learning system includes a learning unit, a data extraction unit, and a data processing unit. The learning unit includes an internal state and an internal parameter. The data extraction unit creates processing input data by removing a part which does not affect an evaluation value calculated by the data processing unit from an input data input in the machine learning system. The data processing unit calculates an evaluation value based on the processing input data and the learning unit. The input data includes discrete values, and an internal state changes according to a change of the input data.

### CROSS-REFERENCE TO RELATED APPLICATION

The present application claims priority from Japanese application JP 2018-158443, filed on Aug. 27, 2018, the contents of which is hereby incorporated by reference into this application.

### BACKGROUND OF THE INVENTION

### 1. Field of the Invention

The present invention relates to a machine learning system which achieves power saving and circuit scale reduction of learning and inference processing in machine learning.

### 2. Description of the Related Art

In recent years, a recognition accuracy of images, sounds, and the like by a computer has improved due to a progress of a machine learning algorithm typified by deep layer learning and the like. Accordingly, application examples of machine learning, such as automated driving and machine translation, are expanding rapidly.

One of the problems when machine learning is applied to a complex problem is that the number of update times of a model parameter required until completion of learning increases. The model parameter corresponds to, for example, a coupling coefficient between neurons in a neural network. When the number of update times increases, the number of calculation times increases proportionally, and learning time increases. Therefore, recently, studies of an algorithm, through which learning is possible even when the number of update times of the model parameter is small, is thriving. Machine learning which uses a Boltzmann machine is also one of them. It has been found that when the Boltzmann machine is used, the number of update times of the model parameter required in learning may be reduced as compared with a case where a neural network is used. Accordingly, learning in a short time becomes possible even for a complicated problem.

US patent number 2017/0323195 A1 (Patent Literature 1) discloses a technique which is related to a reinforcement learning system using a quantum effect, and Republished patent WO2016/194248 (Patent Literature 2) discloses a technique for reducing a required memory capacity by sharing a feedback and a parameter.

As described above, according to the machine learning which uses a Boltzmann machine, although the number of update times of the model parameter can be reduced as compared with the machine learning which uses a neural network, but a scale of a model (the number of parameters and the number of parallel calculation times) is large in many cases. Therefore, power consumption per update of the model parameter and a scale of the implementation circuit increase. Therefore, there is a demand for a technique to reduce power consumption and the scale of the implementation circuit.

Patent Literature 1 describes a technique related to an algorithm in which a transverse magnetic field orthogonal to a direction of a spin of a Boltzmann machine (Ising model) is applied to the spin (two values of an upward one or a downward one) to converge the direction of the spin, and to a reinforcement learning system using the algorithm. Accordingly, it is possible to converge the spin direction at a high speed. However, an increase in power consumption and the implementation circuit scale due to an increase in a scale of the model cannot be avoided, which is the problem described above. Particularly, when a data size of a learning object is large or a complexity degree of the data is high, demerits due to these are large.

Patent Literature 2 describes a technique to reduce a calculation amount and a memory capacity required for machine learning by sharing a feedback and a parameter of a network in the neural network. However, the increase in a model scale when a Boltzmann machine is used in a learning unit cannot be prevented, and power consumption and the implementation circuit scale increase.

### SUMMARY OF THE INVENTION

An object of the invention is to realize power saving and circuit scale reduction of learning and inference processing in machine learning.

An aspect of the invention provides a machine learning system which includes a learning unit, a data extraction unit, and a data processing unit. The learning unit includes an internal state and an internal parameter. The data extraction unit creates processing input data by removing a part which does not affect an evaluation value calculated by the data processing unit from an input data input in the machine learning system. The data processing unit calculates an evaluation value based on the processing input data and the learning unit. The input data includes discrete values, and an internal state changes according to a change of the input data.

Another aspect of the invention provides a method for calculating an energy function of a Boltzmann machine by an information processing device. This method includes a first step of preparing a visible spin having two values as input data of the Boltzmann machine, a second step of creating the processing input data only from information on a visible spin having one value of the two values, and a third step of calculating the energy function based on the processing input data and a coupling coefficient of the Boltzmann machine.

Power saving and circuit scale reduction of learning and inference processing in machine learning can be realized.

### BRIEF DESCRIPTION OF THE DRAWINGS

FIG. 1 is a configuration diagram showing a first embodiment of a machine learning system;

FIG. 2 is an explanatory diagram showing an example of a configuration of a Boltzmann machine;

FIG. 3 is an explanatory diagram showing an example of a coupling coefficient between spins of the Boltzmann machine;

FIG. 4 is an explanatory diagram showing an example of a data format of the coupling coefficient between spins of the Boltzmann machine;

FIG. 5 is a table showing an example of a hyper parameter;

FIG. 6 is an explanatory diagram showing an example of data processing by a data extraction unit in the first embodiment;

FIGS. 7A and 7B are explanatory diagrams showing an effect of calculation circuit reduction according to the application;

FIG. 8 is a configuration diagram showing an example of a configuration of a calculation unit in the first embodiment;

FIG. 9 is a configuration diagram showing a second embodiment of the machine learning system;

FIG. 10 is a flowchart showing an example of an operation flow of the machine learning system in the second embodiment;

FIG. 11 is an explanatory diagram showing an example of data processing by a data extraction unit in the second embodiment;

FIG. 12 is a configuration diagram showing a third embodiment of the machine learning system;

FIG. 13 is a flowchart showing an example of an operation flow of the machine learning system in the third embodiment;

FIGS. 14A and 14B are explanatory diagrams showing an example of data processing by a data extraction unit in the third embodiment;

FIG. 15 is a configuration diagram showing an example of a configuration of a calculation unit in the third embodiment; and

FIG. 16 is a configuration diagram showing an example of a configuration of an updating unit.

### DESCRIPTION OF THE PREFERRED EMBODIMENTS

Embodiments will be described in detail using drawings. However, the invention should not be construed as being limited to description contents of the embodiments described below. It will be easily understood by those skilled in the art that the specific configuration may be modified without departing from the spirit or the scope of the invention.

In the configuration of the invention described below, the same part or a part having a similar function are denoted by the same reference numeral in common among different drawings, and a repetitive description thereof may be omitted.

When a plurality of elements have the same or similar function, different subscripts may be attached to the same reference numeral in some cases. However, when distinguishment among the plurality of elements is not necessary, the subscripts may be omitted in the description.

Expressions such as “first”, “second”, and “third” in the specification are attached to identify a constituent element instead of necessarily limiting a number, an order, or a content thereof. Also, a number for identifying a constituent element is used for an individual context, and may not necessarily indicate the same configuration in another context. In addition, a constituent element identified by a certain number does not interfere with sharing a function of a constituent element identified by another number.

A position, a size, a shape, a range, and the like of a component shown in the drawings and the like may not represent an actual position, size, shape, range, and the like so as to facilitate understanding of the invention. Therefore, the invention is not necessarily limited to the position, the size, the shape, the range, and the like disclosed in the drawings.

A simple example of a system described in the following embodiments is a machine learning system including a data extraction unit, a data processing unit, and a learning unit. The system may include software, hardware, or a combination thereof.

The learning unit (e.g., Boltzmann machine) includes an internal state (e.g., hidden spin) and an internal parameter (e.g., coupling coefficient). The data extraction unit creates a processing input data by removing a part which does not affect an evaluation value (for example, energy function) calculated by the data processing unit from an input data (for example, visible spin) input to the machine learning system. The part that does not affect the evaluation value is, for example, a part where a product with the internal parameter is 0. When the input data is a visible spin, a product of a part where a value of the visible spin is 0 and an internal parameter is 0 regardless of a value of the internal parameter, and accordingly the part can be removed without affecting the evaluation value. The data processing unit calculates an evaluation value based on the processing input data and the learning unit. The input data includes discrete values, and an internal state changes according to a change of the input data.

By using such a configuration, for example, in the Boltzmann machine, an edge connected to a node having a visible spin as 0 can be omitted. Therefore, it is possible to realize power saving and circuit scale reduction of learning and inference processing in machine learning, and to perform learning and inference processing under severe limitations of such as power and the circuit scale.

Hereinafter, embodiments of the machine learning system according to the invention will be described in order. A first embodiment is an example of outputting a calculation value corresponding to a certain input data, a second embodiment is an example of outputting a plurality of corresponding calculation values when a part of data is input, and a third embodiment is an example of updating a model parameter based on input data.

### A. First Embodiment of Machine Learning System

The first embodiment of a machine learning system will be described.

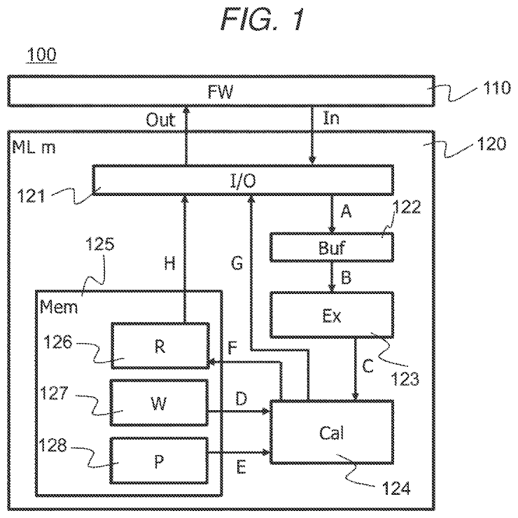

FIG. 1 shows a configuration of the machine learning system. A machine learning system 100 includes a machine learning framework (FW) 110 which integrates and executes processing in machine learning, and a machine learning module (ML m) 120 which executes processing standardized in the machine learning at a high speed. The machine learning framework 110 may be a software library group such as TensorFlow (trademark), Keras, Caffe, Chainer (trademark), and Theano, unique machine learning software, and a machine learning platform provided by company IT vendors, or the like.

The machine learning module 120 includes a data interface unit (I/O) 121 which exchanges data with the machine learning framework 110, a buffer (Buf) 122 which stores data sent from the machine learning framework 110, a data extraction unit (Ex) 123 which extracts and processes data in the buffer, a calculation unit (Cal) 124 which executes a calculation processing based on data sent from the data extraction unit 123, and a memory (Mem) 125 which stores data.

The memory 125 stores a result (R) 126 which replies to the machine learning framework 110 from the machine learning module 120, a coupling coefficient (W) 127 between spins in the Boltzmann machine, and a hyper parameter (P) 128 in the machine learning. The whole machine learning module 120 may be implemented as hardware, and a part or the whole may be implemented as software. Arrows shown in FIG. 1 represent a flow of data and commands. Details of the data and the commands corresponding to each arrow will be described below.

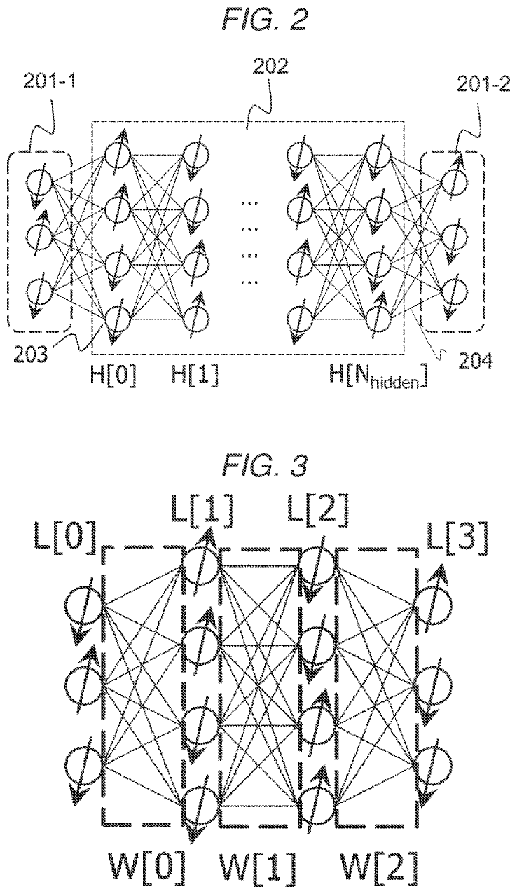

FIG. 2 shows an example of the Boltzmann machine used in the machine learning system. The Boltzmann machine includes visible spins (visible spins 1 and visible spins 2) 201-1 and 201-2 and hidden spins 202. In addition, a coupling coefficient 204 is shown between the spins 203. A visible spin (also referred to as “visible variable”) is a variable which corresponds to an observation data point, and a hidden spin (also referred to as “hidden variable”) is a variable which does not directly correspond to an observation data point.

The visible spin 201 is divided into two so as to input two types of spins with different meanings. For example, in supervised learning typified by image recognition and classification, the visible spin 201-1 is an image data to be learnt, and the visible spin 201-2 is information which relates to classification (cat or dog) of the image data input to the visible spin 201-1. Also, in case of reinforcement learning, the visible spin 201-1 corresponds to a state returned from the environment to an Agent, and the visible spin 201-2 corresponds to an action which replies to the environment from the Agent.

The hidden spin 202 includes one or more layers (a spin 1 column, such as H[0] and the like in the figure), and is referred to a limited Boltzmann machine when the hidden spin includes one layer, and to a deep Boltzmann machine when the hidden spin includes two or more layers. In the example in FIG. 2, spins belonging to adjacent layers are coupled to each other respectively, but a coupling manner is not limited to this example, and the spins may be partially connected. Although the hidden spin has two values in the embodiment, it may also have three or more values.

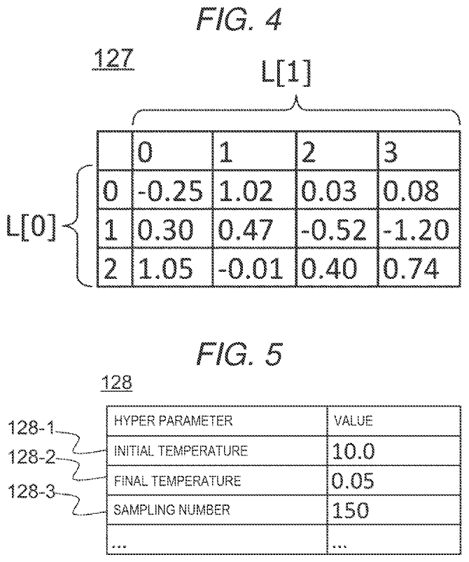

An example of a data format of the coupling coefficient 127 between spins of the Boltzmann machine stored in the memory 125 in the machine learning module 120 will be described in FIGS. 3 and 4.

FIG. 3 is a schematic diagram showing a concept of a layer and a coupling coefficient of the Boltzmann machine, and shows an example in which the hidden spin has two layers which include a visible spin and are sequentially defined as L[0] to L[3]. Coupling coefficients between spins belonging to adjacent layers are defined as W[0] to W[2] for each layer.

FIG. 4 shows an example of the data format of the coupling coefficient 127 between spins. Here, the coupling coefficient W[0] in FIG. 3 is shown. In this example, a table format (two-dimensional array format) is stored in the memory 125, which includes the number of rows corresponding to the number of spins of a left layer (L[0]) in FIG. 3 and the number of columns corresponding to the number of spin of a right layer (L[1]). This is merely an example, and an optimum data format is selected in consideration of limitation of a memory capacity, an order of calculation, a speed of memory access, and the like.

FIG. 5 shows an example of the hyper parameter 128 stored in the memory 125 in the machine learning module 120. The hyper parameter includes an initial temperature 128-1 required for energy calculation of the Boltzmann machine to be described below, a final temperature 128-2, the sampling number of the hidden spin 128-3, and the like.

Next, an example of an operation flow of the machine learning system will be described in the following four steps executed sequentially. In addition, it is also shown, in combination, to which arrow in FIG. 1 data or the like exchanged in each step corresponds.

First, in Step 1, a specific calculation instruction command and input data for the machine learning module 120 to perform calculation are sent from the machine learning framework 110 to the machine learning module 120 (IN, FIG. 1).

A command is largely classified into: (1) a command which performs instruction to output a calculation value corresponding to certain input data; (2) a command which performs instruction to output a corresponding plurality of calculation values when a part of data is input, and (3) a command which performs instruction to update a model parameter based on the input data. A case of (1) will be described in the first embodiment, and (2) and (3) will be described in the second and the third embodiments respectively. The calculation instruction command and the input data are received by the data interface unit 121, and are stored in the buffer 122 (A, FIG. 1).

Subsequently, in Step 2, the data extraction unit 123 uses the calculation instruction command and the input data stored in the buffer 122 (B, FIG. 1) to create processing data. The processing data is sent to the calculation unit 124 (C, FIG. 1).

Next, in Step 3, the calculation unit 124 reads the coupling coefficient 127 and the hyper parameter 128 between spins from the memory 125 (D and E, FIG. 1), and executes calculation based on the processing data sent from the data extraction unit 123. A calculation content is calculation of free energy and internal energy (energy function) of the Boltzmann machine corresponding to the visible spin provided as the input data, and the obtained energy is output as the calculation value and stored as the result 126 in the memory 125 (F, FIG. 1). After the above calculation, the calculation unit 124 sends an error termination flag or a normal termination flag of the calculation to the data interface unit 121 (G, FIG. 1).

Finally, in Step 4, when the data interface unit 121 receives the normal termination flag, a value of the energy calculated by the calculation unit 124 is obtained from the result 126 in the memory 125 (H, FIG. 1), and sent to the machine learning framework 110 (OUT, FIG. 1). When the error termination flag is received, an error content or the like is sent to the machine learning framework 110 (OUT, FIG. 1).

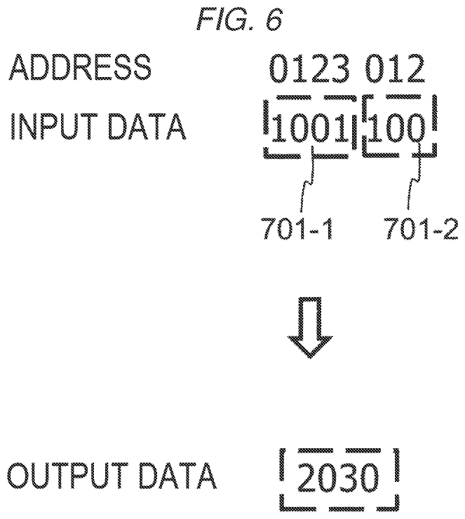

FIG. 6 shows an example of data processing by the data extraction unit 123. In the data processing, first, the data extraction unit 123 acquires the calculation instruction command and the input data stored in the buffer 122 (B, FIG. 1).

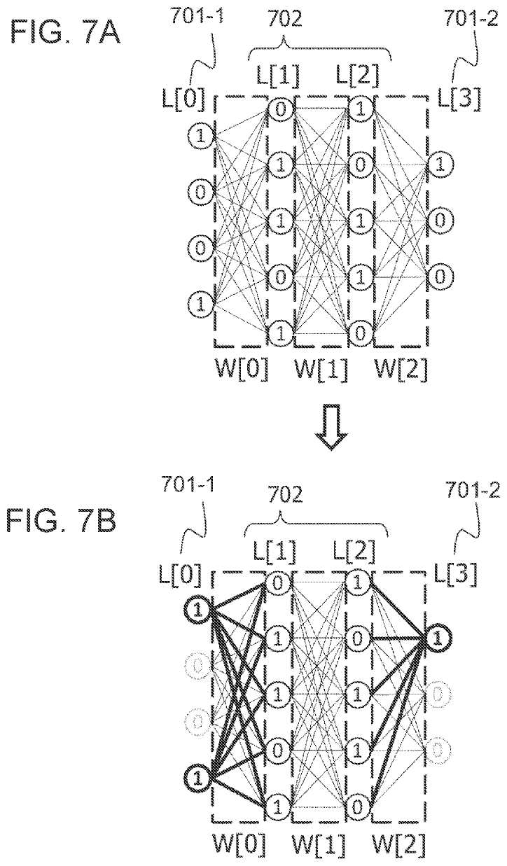

The first embodiment describes the case where the calculation instruction command is “a command which performs instruction to output the calculation value corresponding to the certain input data”. In this case, the input data includes directions of all visible spins (for example, visible spin 701-1 and visible spin 701-2 in FIGS. 7A and 7B). Here, a spin direction which is “1” is an upward direction, and “0” is a downward direction. Although directions of all visible spins are directly described in the input data, the data extraction unit 123 extracts, among the input data, only positions of spins having the upward direction, i.e., having data of “1”, and converts the positions to upward spin position information.

As shown in FIG. 6, addresses representing positions are assigned to the visible spin 701-1 and the visible spin 701-2 respectively. The data extraction unit 123 writes “2” which is the number of upward spins of the visible spin 701-1 at a beginning of the output data. Thereafter, addresses “0” and “3” of upward spins of the visible spin 701-1 are written. Finally, the address “0” of the upward spin of the visible spin 701-2 is written to form the output data “2030”. Information on the number of spins can be used for identifying the visible spin 701-1 and the visible spin 701-2, which are two types of spins having different meanings, in the calculation processing.

As described above, the visible spin 701-2 is used as information which relates to data classification in supervised learning, and as information which indicates actions in reinforcement learning, and thus the number of upward spins is one in any of the cases. Therefore, information which relates to the number of upward spins of the visible spin 701-2 is not described. Of course, an application range of the embodiment is not limited to the above example, and thus the information which relates to the number of upward spins of the visible spin 701-2 may be added if necessary. In this way, the output data created by the data extraction unit 123 is sent to the calculation unit 124 (C, FIG. 1).

FIGS. 7A and 7B show an effect of calculation circuit scale reduction by the processing performing. As described in FIG. 6, before the data processing is performed by the data extraction unit 123, directions of all visible spins (visible spin 701-1 and visible spin 701-2) are expressed by “0” or “1” for each spin. In energy calculation processing described below, a product sum operation of the coupling coefficient between spins and spin values (“0” or “1”) is executed. For example, between a layer (L[0]) of the visible spin 701-1 in FIG. 7A and a first layer (L[1]) of the hidden spin 702, as local energy for each spin of L[1], a product sum of the coupling coefficient and the spin value is executed as follows.

$$LocalEnergy\_L [ 0 ] \_L [ 1 ] [ i ] = {\sum }_{j = 0}^{3} W [ 0 ] [ j ] [ i ] \times L [ 0 ] [ j ]$$

### (Formula 1)

Since the calculation of such local energy is only performed by the number of hidden spins (right and left directions), in the example shown in FIG. 7A, a product calculation of 4×5+5×5×2+3×5=85 times is performed.

Since these calculations need to be performed simultaneously in parallel, it is basically necessary to implement product calculation circuits corresponding to the number of times of the product calculation. However, in case of L[0] [j]=0, j=1, 2, or the like, the product result is 0 even when the product calculation is not performed, and thus unnecessary operation in essence is included.

On the other hand, after the data processing is performed by the data extraction unit 123, only the position of the upward visible spin (the visible spin 701-1 and the visible spin 701-2) is transmitted to the calculation unit 124. Accordingly, as shown in FIG. 7B, only calculation which involves the upward spin in which the result of the product calculation is not zero can be performed. Accordingly, when the following conditions are satisfied, reduction of the number of product calculation circuits to be implemented is reduced, and it is possible to realize reduction of the circuit implementation area and reduction of power consumption due to the calculation. Conditions are that: •a maximum value of the number of upward visible spins is less than the number of all visible spins; and •a maximum value of the number of upward visible spins is known in advance.

Actually, it is known that the above condition is often satisfied in the calculation of the free energy used in popular in the machine learning by the Boltzmann machine. In addition, since all of the hidden spins may take both “0” and “1” during the calculation, it is difficult to reduce the number of product calculation circuits as described above with respect to the hidden spin part.

In FIGS. 7A and 7B, the number of the visible spin is less than the number of the hidden spin. However, for example, when image data is used for learning, each pixel of an image is an eight-bit value as long as each pixel has 256 gradations, and thus it is necessary to simply convert one pixel into eight spins. When learning data having other continuous values, the number of spins is larger than the number of original continuous values. Therefore, in many cases, the number of the visible spin is larger than the number of spins on one layer of the hidden spin. In such a case, the effect of reducing the number of implementation circuits shown in FIG. 7B is more significant.

As is known, in a Boltzmann machine, the local energy is calculated for each spin, and the processing of determining the direction of the spin can be performed based on the local energy. A state of the spin at which the internal energy is minimized can be obtained by this calculation. In addition, in order to avoid falling into a local solution, processing of annealing can be performed by adjusting a flip probability of the spin (probability of changing the direction of the spin) and repeating the calculation.

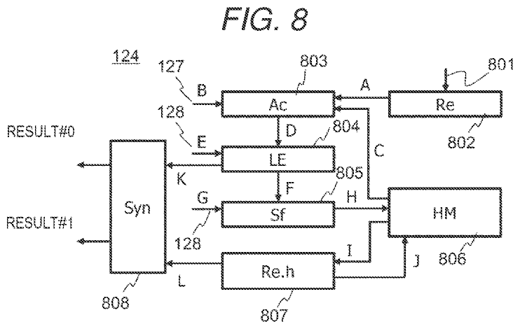

FIG. 8 shows an example of the calculation processing performed by the calculation unit 124. FIG. 8 is a functional block diagram showing the inside of the calculation unit 124 which calculates the free energy. First, the calculation unit 124 receives processing data 801 from the extraction unit 123. The received processing data 801 is stored in a register (Re) 802.

Next, a product sum operation unit (Ac) 803 executes the product sum operation described in FIGS. 7A and 7B using the processing data read from the register 802 (A, FIG. 8), the coupling coefficient 127 (B, FIG. 8) between spins read from the memory 125, and the value of the hidden spin (C, FIG. 8) if necessary. The product sum operation unit 803 sends the result to a local energy unit (LE) 804 (D, FIG. 8).

The local energy unit 804 calculates the flip probability of a spin, and sends the flip probability to a spin flip control unit (Sf) 805 (F, FIG. 8) based on the result and the hyper parameter 128 (E, FIG. 8) read from the memory 125. The spin flip control unit 805 determines whether or not to flip each spin, and sends the result to a hidden spin management unit (HM) 806 based on the flip probability of the spin (H, FIG. 8).

The hidden spin management unit 806, which has received the result of whether to flip each spin, flips a hidden spin of a flip object. Further, the spin flip control unit 805 determines whether the annealing has ended or not based on the hyper parameter 128 (G, FIG. 8) read from the memory 125. If not, the spin flip control unit 805 increments a spin flip cycle by one and sends it to the hidden spin management unit 806 During this, the processing by the product sum operation unit 803 is repeated.

The spin flip cycle is shared among the product sum operation unit 803, the local energy unit 804, and the spin flip control unit 805 through data exchange during the processing described above.

The spin flip control unit 805 determines whether or not the annealing is ended, and determines, when it is ended, whether or not the entire cycle is ended. As a result, if the entire cycle is not ended, the spin flip control unit 805 sends an instruction of taking a snapshot of the hidden spin to the hidden spin management unit 806. Upon receiving the instruction, the hidden spin management unit 806 stores the value of a current hidden spin (spin “0” or “1”) in a hidden spin register (Re.h) 807 (I, FIG. 8), and initializes the value of the hidden spin. During this, the processing by the product sum operation unit 803 is repeated.

Further, when it is determined that the entire cycle is ended, the spin flip control unit 805 sends an instruction of calculating the free energy to the hidden spin management unit 806. Upon receiving the instruction, the hidden spin management unit 806 acquires values of hidden spins stored so far from the hidden spin register 807 (J, FIG. 8), and calculates an average value (this average value is a continuous value from spins 0 to 1) thereof.

Next, the hidden spin management unit 806 sends the average value as the values of the hidden spins to the product sum operation unit 803. The product sum operation unit 803 performs the product sum operation of the processing data (A, FIG. 8) read from the register 802 and the coupling coefficient 127 (B, FIG. 8) between spins read from the memory 125 using the average value of the received hidden spins (C, FIG. 8) in the same manner as the above-described processing, and the result is sent to the local energy unit 804 (D, FIG. 8).

The local energy unit 804 sums the local energy (strictly, subtracting a double count part in the right direction and the left direction of the hidden spins), and sends the summed value and temperature included in the hyper parameter 128 to an integration unit (Syn) 808 (K, FIG. 8).

In parallel with the above processing, the integration unit 808 acquires the values of the hidden spins stored so far from the hidden spin register 807 (L, FIG. 8), and calculates an entropy. Then, the integration unit 808 calculates the free energy using the local energy and the temperature combined with the entropy. Next, the integration unit 808 stores the calculated free energy as the result 126 of the memory 125 (result #0, FIG. 8), and sends an operation error termination flag or a normal end flag to the data interface unit (I/O) (result #1, FIG. 8).

Thus, according to the Boltzmann machine in the first embodiment, the hyper parameter or the coupling coefficient is not changed, and the free energy is calculated with respect to the given value of the visible spin. In this processing, for example, when the Boltzmann machine is set for a certain problem and a solution, certainty of the solution (or certainty of the setting) can be evaluated by the free energy for input of the visible spin 701-1 and the visible spin 701-2 as the problem and the solution. In the first embodiment, the calculation amount for this can be reduced as compared with the related art.

### B. Second Embodiment of Machine Learning System

The second embodiment of the machine learning system will be described. This embodiment corresponds to “(2) a command which performs instruction to output a plurality of corresponding calculation values when a part of data is input”. For example, only a part of visible spins (e.g., 701-1) is input, a combination of other parts of the visible spins (e.g., 701-2) is automatically generated to perform calculation.

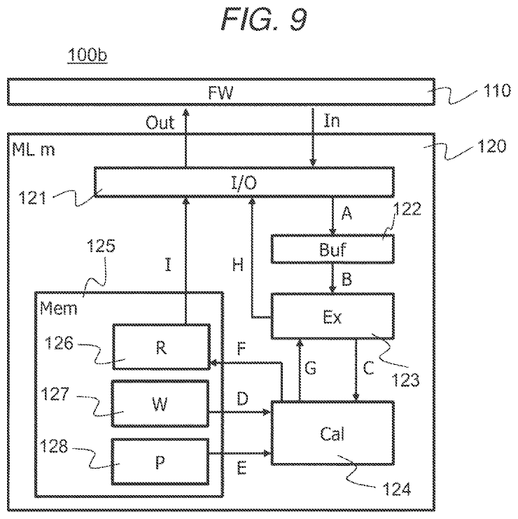

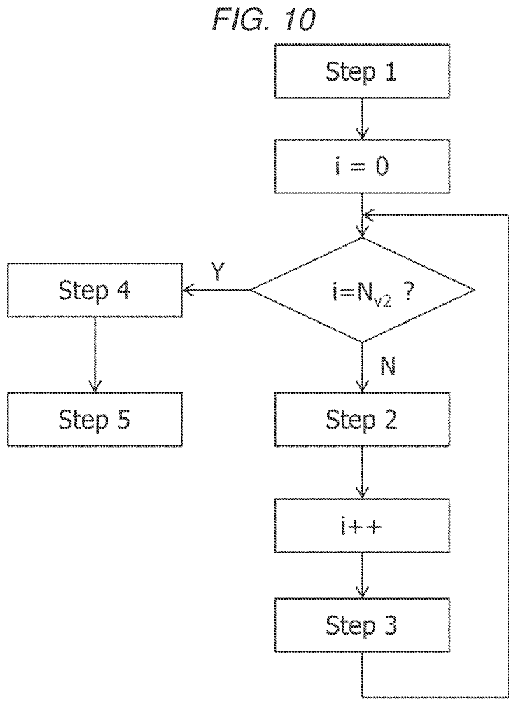

FIG. 9 shows a configuration of a machine learning system 100b. Since names of functional blocks of the machine learning system 100b are the same as those in the first embodiment, a point different from the first embodiment will be described together with an example of an operation flowchart in FIG. 10. A shape of a Boltzmann machine used, a data format of the coupling coefficient (W) 127 between spins, and the hyper parameter (P) 128 are the same as those in the first embodiment.

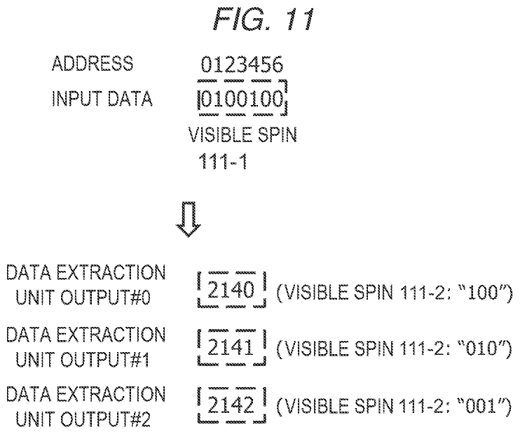

In Step 1 of FIG. 10, calculation of a specific calculation instruction command and input data for the machine learning module 120 to perform calculation are sent from the machine learning framework 110 to the machine learning module 120 (IN, FIG. 9). The input data includes a visible spin 111-1 shown in FIG. 11. The command “performs instruction to output a corresponding plurality of calculation values when a part of data is input”, and includes the number of visible spins 111-2 used by the data extraction unit 123 (Nv2). The calculation instruction command and the input data are received by the data interface unit 121, and stored in the buffer 122 (A, FIG. 9).

Subsequently, the data extraction unit 123 reads out the calculation instruction command and the input data stored in the buffer 122 (B, FIG. 9), and sets a counter indicating repetition to 0 (i=0, FIG. 10).

Next, the data extraction unit 123 reads the value of the counter, and determines whether the value coincides with the number of visible spins 111-2 (Nv2) (i=Nv2?, FIG. 10). If they do not coincide, the process proceeds to Step 2 (N, FIG. 10); if they coincide, the process proceeds to Step 4 (Y, FIG. 10).

Step 2 will be described first. In Step 2, the data extraction unit 123 creates a part of the processing data using the calculation instruction command and the input data, and the data is sent to the calculation unit 124 (C, FIG. 9). After sending the part of the processing data, the data extraction unit 123 increments the value of the counter by one (i++, FIG. 10). A data format of the part of the processing data is the same as the processing data in the first embodiment.

Next, in Step 3, the calculation unit 124 reads the coupling coefficient 127 and the hyper parameter 128 between spins from the memory 125 (D and E, FIG. 9), and calculation is performed based on the part of the processing data sent from the data extraction unit 123. A calculation content is the same as in the first embodiment, free energy and internal energy of the Boltzmann machine corresponding to the visible spin provided as the part of the processing data are calculated, and the obtained energy is output as a calculation value, and stored in the result 126 of the memory 125 (F, FIG. 9).

After the above calculation, the calculation unit 124 sends an error termination flag or a normal termination flag of the calculation to the data extraction unit 123 (G, FIG. 9). After that, the data extraction unit 123 reads the value of the counter, determines whether the value coincides with the number of visible spins 111-2 (Nv2) (i=Nv2?, FIG. 10).

Next, a case where the process proceeds to Step 4 will be described. In Step 4, the data extraction unit 123 sends the error termination flag or the normal end flag of an entire calculation to the data interface unit 121 (H, FIG. 9).

Finally, in Step 5, when the data interface unit 121 receives the normal end flag, the value (exists in a plurality) of the energy calculated by the calculation unit 124 is acquired from the result 126 in the memory 125 (I, FIG. 9) and sent to the machine learning framework 110 (OUT, FIG. 9). When the error termination flag is received, an error content or the like is sent to the machine learning framework 110 (OUT, FIG. 9).

FIG. 11 shows an example of data processing performed by the data extraction unit 123. In the data processing process, first, the data extraction unit 123 acquires the calculation instruction command and the input data stored in the buffer 122. In the second embodiment, a case will be described in which the calculation instruction command “performs instruction to output a corresponding plurality of calculation values when a part of data is input”.

In this case, the input data includes a part of visible spins (only the visible spin 111-1). Here, a spin direction which is “1” is an upward direction, and “0” is a downward direction. Although a direction of the part of the visible spin (only the visible spin 111-1) is directly described in the input data, the data extraction unit 123 extracts, from the input data, a position of a spin having the upward direction, i.e., having data of “1”, and converts the position to upward spin position information. The conversion method is the same as that in the first embodiment.

In addition, in this case, a numeral is added to an end of the data in accordance with the value of the counter described in the previous paragraph. In the example of FIG. 11, for example, when the value of the counter is 0, 0 is added to the end as the part of the processing data (output #0). This corresponds to a case where the visible spin (visible spin 201-2) is “100” in the first embodiment. A number at the end of the data is changed according to the value of the counter (0 to Nv2−1), in other words, the processing data is created for all patterns of the visible spins (visible spins 111-2). In this way, a part of the corresponding processing data is sent one by one from the data extraction unit 123 to the calculation unit 124 with respect to one value of the counter.

In the example of FIG. 11, the outputs #0, #1, and #2 are sequentially output every time the counter is updated with respect to the visible spin 111-1 “0100100” of the input data. The output #0 is “2140” by arranging the number “2” of “1” of the visible spin 111-1, “1” and “4” which are addresses of “1”, and a value “0” of the counter.

In the second embodiment, the processing of Step 2 is executed for each of the outputs #0, #1, and #2 from the data extraction unit 123, and contents thereof are the same as those in the first embodiment. The first embodiment is different from the second embodiment in that a possible combination of the visible spin 111-2 is automatically generated and input in the second embodiment, while in the first embodiment, the visible spin 201-2 is input in advance.

The effect of reducing the calculation circuit scale by the processing process can be expected to be similar to that described in the first embodiment. The calculation processing performed by the calculation unit 124 is also the same as that described in the first embodiment.

### C. Third Embodiment of Machine Learning System

The third embodiment of the machine learning system will be described. This embodiment corresponds to the “(3) command which performs instruction to update the model parameter based on input data”. This embodiment can be used in learning a coupling coefficient and can perform a substantial model learning.

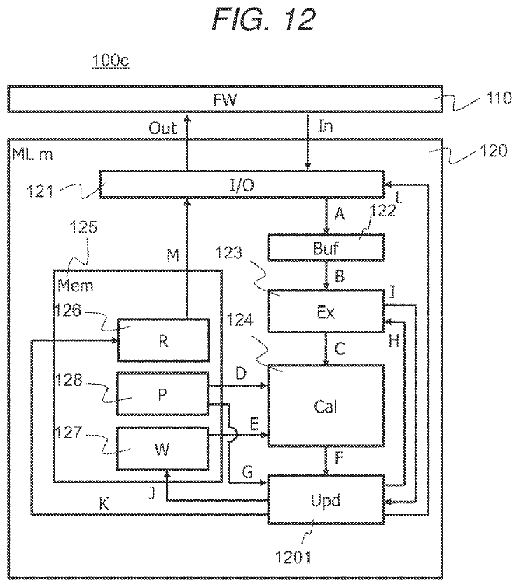

FIG. 12 shows a configuration of a machine learning system 100c. Although a configuration of functional blocks of the machine learning system is substantially the same as those in the first embodiment and the second embodiment, an updating unit (Upd) 1201 which updates the coupling coefficient 127 between spins is newly added as one of a constituent element of the machine learning module 120. A shape of a Boltzmann machine used and a data format of the coupling coefficient 127 between spins are the same as those in the first and second embodiments. Further, in the third embodiment, in order to update the coupling coefficient 127 between spins by the updating unit 1201 in the machine learning module 120, in addition to temperature and the like described in the first and second embodiments, the hyper parameter 128 also includes information about the learning coefficient (learning coefficient), an update algorithm (such as the Stochastic Gradient Descent (SGD), Adaptive Moment Estimation (ADAM)), and a discount rate if in reinforcement learning. Since concepts related to these general learning are well known, a detailed description thereof will be omitted.

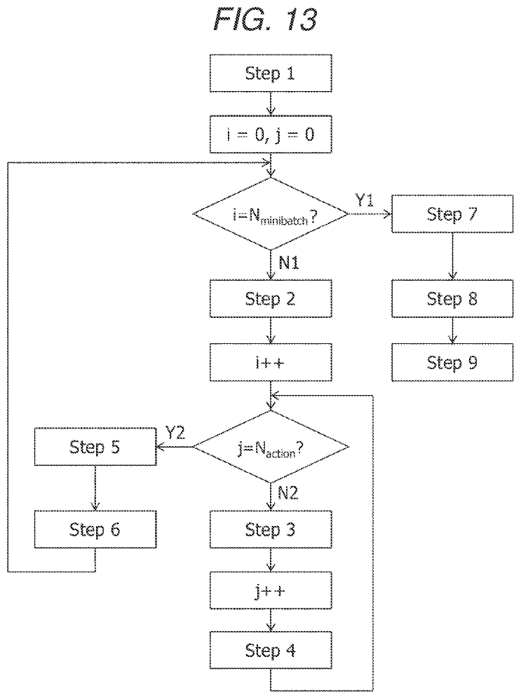

FIG. 13 also shows an example of an operation flowchart in reinforcement learning as an example of machine learning. Arrows shown in FIG. 12 represent flows of data and commands, and are described in conjunction with FIG. 13.

In Step 1 of FIG. 13, a specific calculation instruction command and input data for the machine learning module 120 to perform calculation are sent from the machine learning framework 110 to the machine learning module 120 (IN, FIG. 12). The command “performs instruction to update the model parameter based on the input data”, and includes the number of mini batches (Nminibatch) and the number of actions (Naction) used by the data extraction unit 123.

The number of mini batches corresponds to the number of input data represented by a visible spin 1, for example, the number of images. The number of actions corresponds to the number of input data represented by a visible spin 2, for example, the classification number of the image. A purpose of the learning process in FIG. 13 is to search for a coupling coefficient such that energy is minimized when a combination of the visible spin 1 and the visible spin 2 is in a desired relationship.

The calculation instruction command and the input data are received by the data interface unit 121, and are stored in the buffer 122 (A, FIG. 12). Subsequently, the data extraction unit 123 reads the calculation instruction command stored in the buffer 122 (B, FIG. 12), and sets both a mini batch number counter (i) and an action number counter (j) to 0 (i=0, j=0, FIG. 13).

Next, the data extraction unit 123 reads a value of the mini batch number counter (i), and determines whether the value coincides with the mini batch number (Nminibatch) (i=Nminibatch?, FIG. 13). If they do not match, the process proceeds to Step 2 (N1, FIG. 13); if they match, the process proceeds to Step 7 (Y1, FIG. 13).

First, the above flow will be described from Step 2. In Step 2, the data extraction unit 123 reads a part of the input data stored in the buffer 122 (B, FIG. 12), and processes a part of the read data. Next, the data extraction unit 123 increments the value of the mini batch number counter (i) by one (i++, FIG. 13). Thereafter, the data extraction unit 123 reads the value of the action number counter (j) and determines whether the value coincides with the number of actions (Naction) (j=Naction?, FIG. 13). If they do not coincide, the process proceeds to Step 3 (N2, FIG. 13), and if they coincide, the process proceeds to Step 5 (Y2, FIG. 13).

First, the above flow will be described from Step 3. In Step 3, the data extraction unit 123 processes a remaining part of the data read in Step 2. Then, the processed data is sent to the calculation unit 124 (C, FIG. 12). Next, the data extraction unit 123 increments the value of the action number counter (j) by one (j++, FIG. 13). After that, the calculation unit 124 reads the coupling coefficient 127 and the hyper parameter 128 between spins from the memory 125 (D and E, FIG. 12), and performs calculation based on the processing data received from the data extraction unit 123.

The calculation unit 124 sends the calculation result to the updating unit 1201 (F, FIG. 12). The updating unit 1201 notifies the data extraction unit 123 that the calculation result has been received (H, FIG. 12). Then again, the data extraction unit 123 reads the value of the action number counter (j) and determines whether the value coincides with the number of actions (Naction) (j=Naction?, FIG. 13).

Next, the above flow will be described from Step 5. In Step 5, the data processed in Step 2 is sent to the calculation unit 124 (C, FIG. 12). The calculation unit 124 reads the coupling coefficient 127 and the hyper parameter 128 between spins from the memory 125 (D and E, FIG. 12), and performs calculation based on the processing data received from the data extraction unit 123.

The calculation unit 124 sends the calculation result to the updating unit 1201 (F, FIG. 12). Next, in Step 6, the updating unit 1201 reads the hyper parameter 128 from the memory 125 (G, FIG. 12), and calculates an update amount of the coupling coefficient 127 based on the calculation result received so far. Further, completion of the calculation of the update amount is transmitted to the data extraction unit 123 (H, FIG. 12).

Then again, the data extraction unit 123 reads the value of the mini batch number counter (i) and determines whether the value coincides with the mini batch number (Nminibatch) (i=Nminibatch?, FIG. 13).

Next, the above flow will be described from Step 7. In Step 7, the data extraction unit 123 sends a mini batch number end notification to the updating unit 1201 (I, FIG. 12).

In Step 8, the updating unit 1201, which has received the mini batch number end notification, calculates the final update amount value based on the calculated update amount of the coupling coefficient 127 so far, which is reflected in the coupling coefficient 127 between spins stored in the memory 125 (J, FIG. 12). The updating unit 1201 also stores, in the result 126 in the memory 125, whether or not the update of the coupling coefficient 127 between spins is ended without any error. If an error occurs, the error content is also stored in the result 126 in the memory 125 (K, FIG. 12).

Next, the updating unit 1201 sends an end flag to the data interface unit 121 (L, FIG. 12). In Step 9, the data interface unit 121 which has received the end flag, reads whether or not the update of the coupling coefficient 127 between spins is ended without error from the result 126 in the memory 125. If an error occurs, the data interface unit 121 also reads an error content (M, FIG. 12) and sends it to the machine learning framework 110 (OUT, FIG. 12).

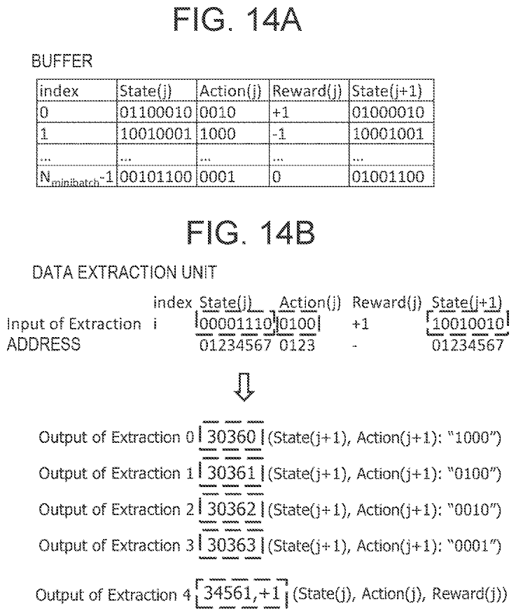

FIGS. 14A and 14B show an example of data processing performed by the data extraction unit 123 as an example of reinforcement learning. In the data processing process, first, the data extraction unit 123 acquires the calculation instruction command stored in the buffer 122. In the third embodiment, a case will be described in which the calculation instruction command “performs instruction to update the model parameter based on the input data”. An example of the input data stored in the buffer 122 is shown in FIG. 14A.

The input data includes data parts whose index is from 0 to the mini batch number (Nminibatch)−1, and each data part includes a current state (State(j)), an action to be executed under the current state (Action(j)), a reward (Reward(j)), and a next state (State(j+1)). From the viewpoint of input data, as in cases of the first embodiment and the second embodiment, “1” shows an upward spin and “0” shows a downward spin. The current state (State(j)) and the next state (State(j+1)) correspond to a visible spin 1, and the action (Action(j)) executed under the current state correspond to a visible spin 2.

The data extraction unit 123 reads a data part corresponding to the value of the mini batch number counter (i) from the buffer 122, and the data parts are processed sequentially one by one. Further, the data parts are not all processed at a time, and the processing is partially performed in accordance with a value of the action number counter (j). When the value of the action number counter (j) is 0 to the number of actions (Naction)−1, the next state (State(j+1)) and the action to be executed under the next state (Action (j+1)) in the data parts are processed (Output of Extraction 0-3) and sent to the calculation unit (Calculation). This is processing corresponding to Step 3 in FIG. 13.

On the other hand, when the value of the action number counter (j) is the number of actions (Naction), the current state (State (j)) and the action to be executed under the current state (Action (j)) are processed (Output of Extraction 4) and sent to the calculation unit 124 together with a reward value. This is processing corresponding to Step 5 in FIG. 13. The effect of reducing the calculation circuit scale according to the processing can be expected to be similar to that described in the first embodiment.

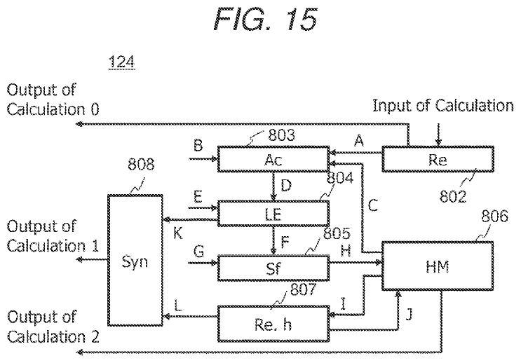

FIG. 15 shows an example of the calculation process performed by the calculation unit 124. FIG. 15 is a functional block diagram showing the inside of the calculation unit 124 for the calculation of the free energy. First, the calculation unit 124 receives the processing data from the extraction unit 123 (Input of Calculation). The processing data can be classified into two types, the first is data which only includes information on a direction of a visible spin (Visible spins 1 and Visible spins 2, for example Visible spins 701-1 and Visible spins 701-2 in FIGS. 7A and 7B) (corresponding to Output of Extraction 3 in FIG. 14B), and the second is data added with a reward, in addition to the information on a direction of a visible spin (corresponding to Output of Extraction 4 in FIG. 14B).

In the following, first, a case in which only information on a direction of a visible spin is included in the processing data will be described. In this case, an operation flow of the calculation unit 124 is substantially the same as the content described in <A>, and the processing data received by the calculation unit 124 is stored in the register 802 at first.

Next, the product sum operation unit 803 executes the product sum operation described using FIGS. 7A and 7B using the processing data read from the register (A, FIG. 15), the coupling coefficient 127 between spins read from the memory 125 (B FIG. 15), and the value of the hidden spin as necessary (C, FIG. 15). The product sum operation unit 803 sends the result to the local energy unit 804 (D, FIG. 15).

The local energy unit 804 calculates a flip probability of a spin (probability of changing a direction of a spin) and sends the flip probability to the spin flip control unit 805 (F, FIG. 15) based on the result and the hyper parameter 128 read from the memory 125 (E, FIG. 15). The spin flip control unit 805 determines whether or not each spin is flipped based on the flip probability of the spin, and the result is sent to the hidden spin management unit 806 (H, FIG. 15).

The hidden spin management unit 806, which has received the result of whether to flip each spin, flips the hidden spin of a flip object. Further, the spin flip control unit 805 determines whether the annealing has ended or not based on the hyper parameter 128 (G, FIG. 15) read from the memory 125. If not, the spin flip control unit 805 increments a spin flip cycle by one, and sends the spin flip cycle to the hidden spin management unit 806.

During this, the processing by the product sum operation unit 803 is repeated. The spin flip cycle is shared among the product sum operation unit 803, the local energy unit 804, and the spin flip control unit 805 through data exchange during the processing described above.

The spin flip control unit 805 determines whether or not the annealing of is ended, and determines, when it is ended, whether or not the entire cycle is ended. As a result, if the entire cycle is not ended, the spin flip control unit 805 sends an instruction of taking a snapshot of the hidden spin to the hidden spin management unit 806.

Upon receiving the instruction, the hidden spin management unit 806 stores a value of a current hidden spin (each spin “0” or “1”) in the hidden spin register 807 (I, FIG. 15), and initializes the value of the hidden spin. During this, the processing by the product sum operation unit 803 is repeated.

Further, when it is determined that the entire cycle is ended, the spin flip control unit 805 sends an instruction of calculating the free energy to the hidden spin management unit 806. Upon receiving the instruction, the hidden spin management unit 806 acquires values of hidden spins stored so far from the hidden spin register 807 (J, FIG. 15), and calculates an average value (this average value is the continuous value from each spin 0 to 1) thereof.

Next, the hidden spin management unit 806 sends the average value as the values of the hidden spins to the product sum operation unit 803. The product sum operation unit 803 performs the product sum operation of the processing data (A, FIG. 15) read from the register and the coupling coefficient 127 (B, FIG. 15) between spins read from the memory 125 using the average value of the received hidden spins (C, FIG. 15) in the same manner as the above-described processing, and the result is sent to the local energy unit 804 (D, FIG. 15).

The local energy unit 804 sums the local energy (strictly, subtracting the double count part in the right direction and the left direction of the hidden spins), and sends the summed value and temperature included in the hyper parameter 128 to the integration unit 808 (K, FIG. 15). In parallel with the above processing, the integration unit 808 acquires the values of the hidden spins stored so far from the hidden spin register 807 (L, FIG. 15), and calculates an entropy.

Then, the integration unit 808 calculates the free energy using the local energy and the temperature combined with the entropy. Next, the integration unit 808 sends the calculated free energy to the updating unit 1201 (Output of Calculation 1, FIG. 15).

Next, a case in which the reward in addition to the information on a direction of a visible spin is included in the processing data will be described. The difference will be described since a part of the operation flow of the calculation unit 124 in this case is common to the first example. First, the calculation unit 124 sends the processing data to the updating unit 1201 after receiving the processing data (Output of Calculation 0, FIG. 15). Further, the free energy calculated in the same flow as the first example is sent to the updating unit 1201 (Output of Calculation 1, FIG. 15). Thereafter, the calculation unit 124 sends the average value of the hidden spins stored in the hidden spin management unit 806 to the updating unit 1201 (Output of Calculation 2, FIG. 15).

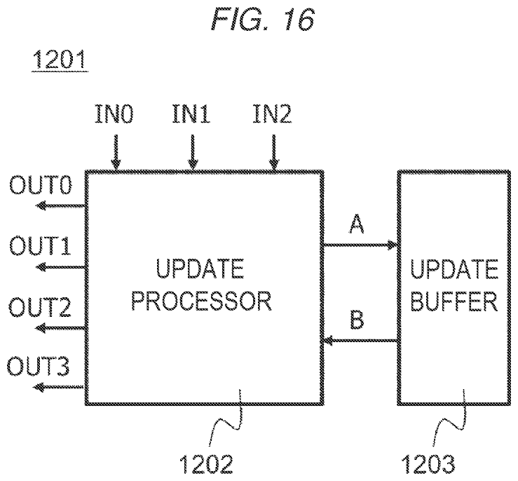

FIG. 16 shows an example of update processing of the coupling coefficient 127 between spins performed by the updating unit 1201. FIG. 16 is a functional block diagram showing the inside of the updating unit 1201 for the update processing. The updating unit 1201 includes an update processor 1202 and an update buffer 1203.

First, data is sent from the calculation unit 124 to the update processor 1202 (IN0, FIG. 16; F, FIG. 12). The data includes two types: a case of including only free energy; and a case of including processing data processed by the extraction unit 123 and the average value of the hidden spins in addition to the free energy. In the former case, the update processor 1202 stores the free energy sent from the calculation unit 124 in the update buffer 1203 (A, FIG. 16), and sends a free energy reception notification to the extraction unit 123 (OUT0, FIG. 16; H, FIG. 12). In the latter case, the update amount of the coupling coefficient 127 between spins is calculated using free energy received so far, the processing data, and the average value of the hidden spins, and the update amount is stored in the update buffer 1203 (A, FIG. 16).

In calculation of the update amount, for example, in supervised learning, the coupling coefficient 127 is changed to ensure a value of the free energy corresponding to a correct answer to be chosen more easily as compared with a value of the free energy corresponding to another incorrect answer label (generally decreasing). In reinforcement learning, the coupling coefficient 127 is changed to ensure a sum of future reward values corresponding to the action to coincide with a negative free energy (one obtained by inverting positive free energy and negative free energy).

Thereafter, a calculation completion notification of the update amount of the coupling coefficient 127 between spins is sent to the extraction unit 123 (OUT0, FIG. 16; H, FIG. 12). When receiving the mini batch number end notification from the extraction unit 123 (IN1, FIG. 16; I, FIG. 12), the update processor 1202 reads the update amount of the coupling coefficient 127 between spins stored so far from the update buffer 1203 (B, FIG. 16), obtains, for example, an average therefrom, calculates a final update amount of the coupling coefficient between spins, and reflects the final update amount to the value of the coupling coefficient 127 between spins stored in the memory 125 (OUT1, FIG. 16; J, FIG. 12).

Thereafter, the update processor 1202 deletes the update amount of the coupling coefficient 127 between spins stored in the update buffer 1203 so far. Next, the update processor 1202 stores, in the result 126 in the memory 125, whether or not the update of the coupling coefficient 127 between spins is ended without any error. If an error occurs, the error content is also stored in the result 126 in the memory 125 (OUT2, FIG. 16; K, FIG. 12). Thereafter, the update processor 1202 sends the end flag to the data interface unit 121 (OUTS, FIG. 16; L, FIG. 12).

Although an example of reinforcement learning is mainly described in the third embodiment, the scope of the embodiment is not limited to reinforcement learning, and may be applied to supervised learning. In this case, as described in the first and second embodiments, the state corresponds to the visible spin 1 and action corresponds to the visible spin 2.

In the above three embodiments <A>, <B> and <C>, the calculation unit 124 calculates the free energy of the Boltzmann machine, but the expression of the evaluation function is not limited to the free energy, and may be expressed by, for example, internal energy (excluding terms of the entropy from the free energy). Here, the evaluation function corresponds to an action value function, a state value function, or the like in the reinforcement learning, and corresponds to a probability that the input data belongs to each classification in the supervised learning.

As described in the first embodiment, the machine learning framework 110 may be software or a platform, and may also be hardware in conjunction with the machine learning module 120 (or integrated type). On the other hand, the machine learning module 120 is not limited to the hardware, and a part of or the whole the machine learning module 120 may be implemented as the software. In the above three embodiments <A>, <B> and <C>, the machine learning system includes the machine learning framework 110 and the machine learning module 120, but the machine learning module 120 may also be provided with functions of a machine learning framework (including input and output of the machine learning command and input and output of learning data according to a user).

### D. Summary of Effects of Embodiments

The main effects obtained by the embodiments described above are as follows.

By applying the first embodiment, when the evaluation value is calculated in the machine learning, the calculation circuit scale necessary for calculating the evaluation value is reduced by removing a part that does not affect the calculation of the evaluation value from the input data (processing the data). Accordingly, it is possible to reduce a circuit area and reduce power consumption during calculation. By applying the second embodiment, a plurality of evaluation values can be calculated from the input data. Accordingly, in addition to effects obtained when the first embodiment is applied, it is possible to reduce the number of input times of data when one evaluation value is calculated, and to calculate an evaluation value at a higher speed. By applying the third embodiment, a part that does not affect the calculation of the evaluation value is removed from the input data (processing the data), and a parameter of a model for determining the evaluation value can be updated (learned) based on the evaluation value. Accordingly, it is possible to reduce the operational circuit scale necessary for the learning process in the machine learning, and reduce the circuit area and power consumption during learning.

In the description of the above embodiments, the machine learning system is showed as a block diagram divided for each function, such as a machine learning framework, a data interface unit, a data extraction unit, a calculation unit, and a updating unit. However, in addition to the above-described functional division, a function of processing data, a function of calculating an evaluation value, and a function of updating a parameter of a model may also be included. Implementation forms may also be a dedicated circuit such as an ASIC, a programmable logic such as an FPGA, a built-in microcomputer, and software operating on a CPU or a GPU. Alternatively, a combination thereof may be implemented for each function.

As described above in detail, by employing the technique of the above embodiments, it is possible to prevent an increase in power consumption and the implementation circuit scale due to an increase in the model scale when a Boltzmann machine is used in a learner (when compared with a neural network), and to reduce the number of update times of a model parameter required for learning and learning time and power consumption in machine learning.

While the embodiments have been described above with reference to the attached drawings, preferable embodiments are not limited thereto, and various changes and modifications may be made in a scope without departing from the spirit of the invention.

What is claimed is:

1. A machine learning system comprising a learning unit, a data extraction unit, and a data processing unit, wherein
the learning unit includes an internal state and an internal parameter,
the data extraction unit creates processing input data by removing a part that does not affect an evaluation value calculated by the data processing unit from input data input in the machine learning system,
the data processing unit calculates the evaluation value based on the processing input data and the learning unit,
the input data includes discrete values, and
the internal state changes according to a change of the input data.

2. The machine learning system according to claim 1, wherein
the learning unit includes a Boltzmann machine, and
the internal state includes two discrete values.

3. The machine learning system according to claim 1, wherein
the learning unit includes a Boltzmann machine,
the input data includes two discrete values, and
the data extraction unit creates the processing input data based on one value of the two values.

4. The machine learning system according to claim 3, wherein
another value of the two values is a value whose product with the internal parameter is 0.

5. The machine learning system according to claim 4, wherein
the internal parameter is a coupling coefficient of the Boltzmann machine.

6. The machine learning system according to claim 4, wherein
the input data is a visible spin of the Boltzmann machine.

7. The machine learning system according to claim 6, wherein
the visible spin includes a first visible spin and a second visible spin, and
the processing input data includes information that specifies a number and a position of the one value included in the first visible spin.

8. The machine learning system according to claim 1, wherein
when the data processing unit calculates the evaluation value, the processing input data, only a part of the internal state, and only a part of the internal parameter are used.

9. The machine learning system according to claim 1, further comprising:
an internal parameter updating unit, wherein
the internal parameter updating unit updates the internal parameter using the evaluation value calculated by the data processing unit.

10. A Boltzmann machine calculation method for calculating an energy function of a Boltzmann machine by an information processing device, the method comprising:
a first step of preparing a visible spin having two values as input data of the Boltzmann machine;
a second step of creating processing input data only from information on a visible spin having one value of the two values; and
a third step of calculating the energy function based on the processing input data and a coupling coefficient of the Boltzmann machine.

11. The Boltzmann machine calculation method according to claim 10, wherein
the two values are “1” and “0”, and the processing input data is created only from information on a visible spin having “1” in the second step.

12. The Boltzmann machine calculation method according to claim 10, wherein
in the second step, information which indicates a number of a visible spin having the one value is added to the processing input data.

13. The Boltzmann machine calculation method according to claim 12, wherein
in the first step, the visible spin includes a first visible spin and a second visible spin, and
in the second step, information which indicates a number and a position of a visible spin having the one value in the first visible spin is added to the processing input data.

14. The Boltzmann machine calculation method according to claim 10, further comprising:
a fourth step of updating the coupling coefficient based on the energy function calculated in the third step.

15. The Boltzmann machine calculation method according to claim 10, wherein
in the second step, when the processing input data is created only from the information on a visible spin having one of the two values, a visible spin having another value of the two values does not affect a calculation result in a product sum operation in energy calculation in the third step.
